(19) United States
(12) Patent Application Publication
(10) Pub. No.: US 2026/0281777 A1
(43) Pub. Date: Sep. 17, 2026

(54) METHODS, ARCHITECTURES, APPARATUSES AND SYSTEMS FOR LAYER 1/LAYER 2 TRIGGERED MOBILITY (LTM) MEASUREMENT REPORTING

(71) Applicant: InterDigital Patent Holdings, Inc., Wilmington, DE (US)

(72) Inventors: Brian Martin, Farnham (GB); Oumer Teyeb, Montreal (CA); Martino Freda, Laval (CA); Paul Marinier, Brossard (CA); Erdem Bala, East Meadow, NY (US); Dylan Watts, Montreal (CA); Keiichi Kubota, Setagaya-Ku (JP)

(21) Appl. No.: 19/472,389

(22) PCT Filed: Apr. 4, 2024
(86) PCT No.: PCT/US2024/023062

§ 371 Date: Oct. 3, 2025

Related U.S. Application Data
(60) Provisional application No. 63/456,940, filed on Apr. 4, 2023.

(51) Int. Cl. H04W 24/10; H04W 76/19

(52) U.S. Cl. CPC H04W 24/10; H04W 76/19

(57) ABSTRACT

Procedures, methods, architectures, apparatuses, systems, devices, and computer program products for layer 1/layer 2 (L1/2) triggered mobility (LTM). For example, a wireless transmit/receive unit (WTRU) may information indicating a RRC reconfiguration message including information indicating LTM suspension and a time period. The WTRU may (e.g., perform the RRC reconfiguration and) send a RRC reconfiguration complete message. The WTRU may receive a LTM switch command. The WTRU may send information indicating that the LTM switch command is not executed based on an elapsed time from reception of the RRC reconfiguration message being less than the time period or an elapsed time from transmission of the RRC reconfiguration complete message being less than the time period.

### CROSS-REFERENCE TO RELATED APPLICATIONS

This application claims the benefit of U.S. Provisional Patent Application No. 63/456,940 filed 4 Apr. 2023 which is incorporated herein by reference.

### TECHNICAL FIELD

The present disclosure is generally directed to the fields of communications, software and encoding, including, for example, to methods, architectures, apparatuses, systems directed to procedures for mobility, and more particularly to LTM use.

### BACKGROUND

A wireless transmit/receive unit (WTRU) may be configured to use LTM. It would be desirable to provide, when LTM is configured, along with measurement and measurement reporting mechanisms to support LTM, procedures for LTM to run in parallel, or coexist, with radio resource control (RRC) based measurements and mobility.

### SUMMARY

In an example embodiment, a WTRU may (e.g., implement a method to) receive information indicating configuration information associated with a quality for LTM. The WTRU may receive information indicating a measurement event. The WTRU may determine the quality for a first LTM set based on measurements of a first set of beams from a first plurality of cells. The WTRU may send a measurement report associated with the measurement event and/or perform a conditional reconfiguration based on, for example, (1) the measurement event being satisfied using the determined quality for the first LTM set and (2) an elapsed time since a last LTM cell switch.

For example, the WTRU may determine the quality for a second LTM set based on measurements of a second set of beams from a second plurality of cells. The measurement event may be (e.g., determined to be) satisfied using the determined quality for the first LTM set and the determined quality for the second LTM set. For example, the WTRU may determine the first set of beams as a subset of a (e.g., first) plurality of beams from the first plurality of cells and/or the second set of beams as a subset of a (e.g., second) plurality of beams from the second plurality of cells. For example, the WTRU may determine a quality for a serving or target cell outside of the first LTM set. The measurement event may be (e.g., determined to be) satisfied using the determined quality for the first LTM set and the determined quality for the serving or target cell. For example, the WTRU may perform the last LTM switch before the measurement event is satisfied. For example, the measurement report may include information indicating the determined quality for the first LTM set and/or the conditional reconfiguration may include sending the information indicating the determined quality for the first LTM set.

In certain representative embodiments, a virtual cell quality derivation and/or a modified cell quality derivation may be performed. For example, beams from different cells with a L1/L2 triggered mobility (LTM) candidate set may be used and/or considered to derive the LTM candidate set's virtual cell quality.

In certain representative embodiments, a WTRU may be configured with an active LTM set and a target LTM set. Cell quality derivation and/or comparison may be performed as in legacy procedures, such as using N L1 filtered beam measurements on a cell to derive L3 filtered cell quality. At least one additional triggering condition may (e.g., shall) be fulfilled by a certain number of cells in the target and/or source candidate set.

In certain representative embodiments, a WTRU may switch from a first serving cell to a second serving cell using LTM. When switching, the WTRU may determine a L3 cell quality and evaluate a L3 event trigger based on measurement results applicable to first and second serving cells, such as if the first and second serving cells are a single serving cell. For example, a WTRU may continue evaluation of a (e.g., current) serving cell quality and the measurement event trigger even after a cell change, using the previous serving cell(s) measurements as if they were the current cell measurements.

In certain representative embodiments, a WTRU may perform procedures which allow radio resource control (RRC) reconfiguration complete signaling to be successfully delivered, such as to a centralized unit (CU) of a gNB, after L3 handover, and/or to allow a L3 measurement event evaluation to be completed (e.g., while a time-to-trigger is running). For example, a WTRU may be prevented from sending L1 measurement reports and/or executing LTM which may result in distributed unit (DU) triggered LTM handover and L3 signaling being lost, and/or which may result in a CU detecting handover failure or reconfiguration failure. For example, a WTRU may apply a (e.g., temporary) restriction on neighbor and/or candidate cell L1 reporting, such as with current cell beam reporting still enabled to allow scheduling, by using a timer and/or by waiting for RLC acknowledgement of RRC message (complete) transmission.

In certain representative embodiments, a WTRU may include information indicating a PCell identifier/identity in an uplink (UL) RRC message. For example, the PCell ID may correspond to the PCell at the time the event was triggered (e.g., a measurement event, a RRC reconfiguration). In cases of RRC Reconfiguration, RRC Reconfiguration complete signaling may include information indicating whether RRC Reconfiguration, L2 triggered reconfiguration, or both, have been performed.

In certain representative embodiments, a WTRU may receive configuration information associated with determining LTM quality. The configuration information may include any of: (i) a minimum number of beams and/or cells to use in determining the LTM quality, (ii) offset and/or scaling information, (iii) an association between one or more beams of a serving cell and one or more beams of other cells, and/or (iv) an indication to use LTM quality as a serving cell quality or as an offset to the serving cell quality. The WTRU may receive configuration information indicating a L1 or L3 (L1/L3) measurement event which is associated with a triggering condition. The WTRU may perform first measurements of the one or more beams of the serving cell and the one or more beams of the other cells associated with the serving cell. The WTRU 102 may determine a first LTM quality using the first measurements and the configuration information associated with determining LTM quality. The WTRU may send a report, which includes information indicating the first LTM quality, associated with the L1/L3 measurement event based on the triggering condition being satisfied and a minimum time period since a last LTM cell switch having elapsed.

In certain representative embodiments, a WTRU may receive configuration information associated with determining Layer 1 or Layer 2 (L1/L2) triggered mobility (LTM) quality. For example, the configuration information may include any of: (i) a minimum number of beams and/or cells to use in determining the LTM quality, (ii) offset and/or scaling information, (iii) an association between one or more beams of a target cell and one or more beams of other cells, and/or (iv) an indication to use LTM quality as a target cell quality or as an offset to the target cell quality. The WTRU may receive configuration information indicating a L1 or L3 (L1/L3) measurement event which is associated with a triggering condition. The WTRU may perform first measurements of the one or more beams of the target cell and the one or more beams of the other cells associated with the target cell. The WTRU may determine a first LTM quality using the first measurements and the configuration information associated with determining LTM quality. The WTRU 102 may send a report, which includes information indicating the first LTM quality, associated with the L1/L3 measurement event based on the triggering condition being satisfied and a minimum time period since a last LTM cell switch having elapsed.

In certain representative embodiments, a WTRU may receive configuration information associated with determining Layer 1 or Layer 2 (L1/L2) triggered mobility (LTM) quality. The configuration information may include any of: (i) a minimum number of beams and/or cells to use in determining the LTM quality, (ii) offset and/or scaling information, (iii) an association between one or more beams of a serving cell and one or more beams of other cells, and/or (iv) an indication to use LTM quality as a serving cell quality or as an offset to the serving cell quality. The WTRU 102 may receive configuration information indicating a L1 or L3 (L1/L3) measurement event which is associated with a triggering condition. The WTRU may perform first measurements of the one or more beams of the serving cell and the one or more beams of the other cells associated with the serving cell. The WTRU may determine a first LTM quality using the first measurements and the configuration information associated with determining LTM quality. The WTRU may perform a conditional reconfiguration associated with the L1/L3 measurement event based on the triggering condition being satisfied and a minimum time period since a last LTM cell switch having elapsed.

In certain representative embodiments, a WTRU may receive configuration information associated with determining Layer 1 or Layer 2 (L1/L2) triggered mobility (LTM) quality. The configuration information may include any of: (i) a minimum number of beams and/or cells to use in determining the LTM quality, (ii) offset and/or scaling information, (iii) an association between one or more beams of a target cell and one or more beams of other cells, and/or (iv) an indication to use LTM quality as a target cell quality or as an offset to the target cell quality. The WTRU may receive configuration information indicating a L1 or L3 (L1/L3) measurement event which is associated with a triggering condition. The WTRU may perform first measurements of the one or more beams of the target cell and the one or more beams of the other cells associated with the target cell. The WTRU may determine a first LTM quality using the first measurements and the configuration information associated with determining LTM quality. The WTRU may perform a conditional reconfiguration associated with the L1/L3 measurement event based on the triggering condition being satisfied and a minimum time period since a last LTM cell switch having elapsed.

In certain representative embodiments, a WTRU may receive configuration information associated with determining cell quality using L3 filtering. The WTRU may receive configuration information indicating a measurement event associated with using a time-to-trigger (TTT) period and an offset. The WTRU may determine the measurement event is met at a start of a first time period based on a first triggering condition using a quality of a first serving cell using the L3 filtering and a quality of a neighbor cell. The WTRU may receive information indicating to switch the first serving cell to a second serving cell using layer 1/layer 2 triggered mobility (LTM) at an end of the first time period, wherein the first time period is less than the TTT period. The WTRU may determine that the measurement event is met based on a second triggering condition, during a second time period, based on a quality of the second serving cell during the second time period using the L3 filtering, and a quality of a neighbor cell, wherein the second time period is after the first time period, and a sum of the first time period and the second time period is greater than or equal to the TTT period. The WTRU may send, based on the quality of the neighbor cell being greater than a measurement result of the second serving cell plus the offset, a measurement report including information indicating any of (i) the first serving cell and the second serving cell, and/or (ii) the first and second time periods.

In certain representative embodiments, a WTRU may receive a RRC reconfiguration message including information indicating LTM measurement suspension and a time period (e.g., associated with the LTM suspension). The WTRU may send a RRC reconfiguration complete message. The WTRU may receive a LTM switch command. The WTRU may send information indicating that the LTM switch command is not executed based on an elapsed time from reception of the RRC reconfiguration message being less than the indicated time period. The WTRU may send a LTM measurement report based on the elapsed time from the reception of the RRC reconfiguration message being greater than the indicated time period.

In certain representative embodiments, a WTRU may receive a RRC reconfiguration message including information indicating LTM measurement suspension and a time period (e.g., associated with the LTM suspension). The WTRU may send a RRC reconfiguration complete message. The WTRU may receive a LTM switch command. The WTRU may send information indicating that the LTM switch command is not executed based on an elapsed time from transmission of the RRC reconfiguration complete message being less than the time period. The WTRU may send a LTM measurement report based on the elapsed time from the reception of the RRC reconfiguration message being greater than the indicated time period.

In certain representative embodiments, a WTRU may receive a RRC reconfiguration message including information indicating LTM measurement suspension and a time period (e.g., associated with the LTM suspension). The WTRU may send a RRC reconfiguration complete message. The WTRU may receive a LTM switch command. The WTRU may send information indicating that the LTM switch command is not executed based on an elapsed time from reception of the RRC reconfiguration message being less than the indicated time period. The WTRU may send a LTM measurement report based on the elapsed time from the sending of the RRC reconfiguration complete message being greater than the indicated time period.

In certain representative embodiments, a WTRU may receive a RRC reconfiguration message including information indicating LTM measurement suspension and a time period (e.g., associated with the LTM suspension). The WTRU may send a RRC reconfiguration complete message. The WTRU may receive a LTM switch command. The WTRU may send information indicating that the LTM switch command is not executed based on an elapsed time from transmission of the RRC reconfiguration complete message being less than the time period. The WTRU may send a LTM measurement report based on the elapsed time from the sending of the RRC reconfiguration complete message being greater than the indicated time period.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram illustrating an example of a measurement model;

FIG. 3 is a system diagram illustrating an example of LTM operation;

FIG. 4 is a procedural diagram illustrating a baseline procedure for LTM;

FIG. 5 is a system diagram illustrating examples of intra-CU and inter-CU switching;

FIG. 6 is a procedural diagram illustrating an example procedure for LTM measurement and execution suspension after a L3 reconfiguration;

FIG. 7 is a procedural diagram illustrating an example LTM procedure according to certain representative embodiments;

FIG. 8 is a procedural diagram illustrating an example procedure for LTM measurement suspension and measurement reporting;

FIG. 9 is a procedural diagram illustrating another example procedure for LTM measurement suspension and measurement reporting;

FIG. 10 is a procedural diagram illustrating yet another example procedure for LTM measurement suspension and measurement reporting; and

FIG. 11 is a procedural diagram illustrating still another example procedure for LTM measurement suspension and measurement reporting.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

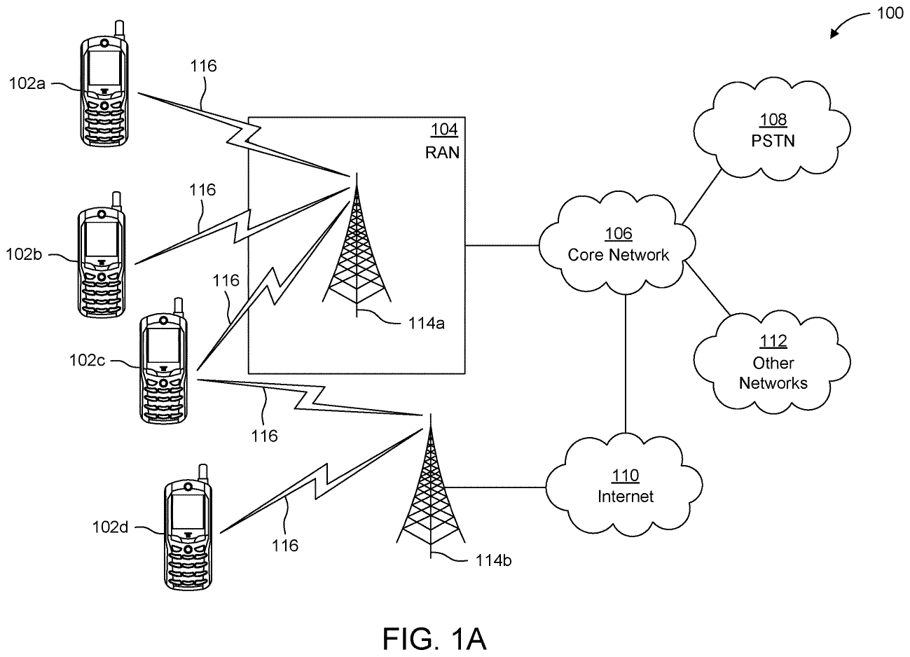

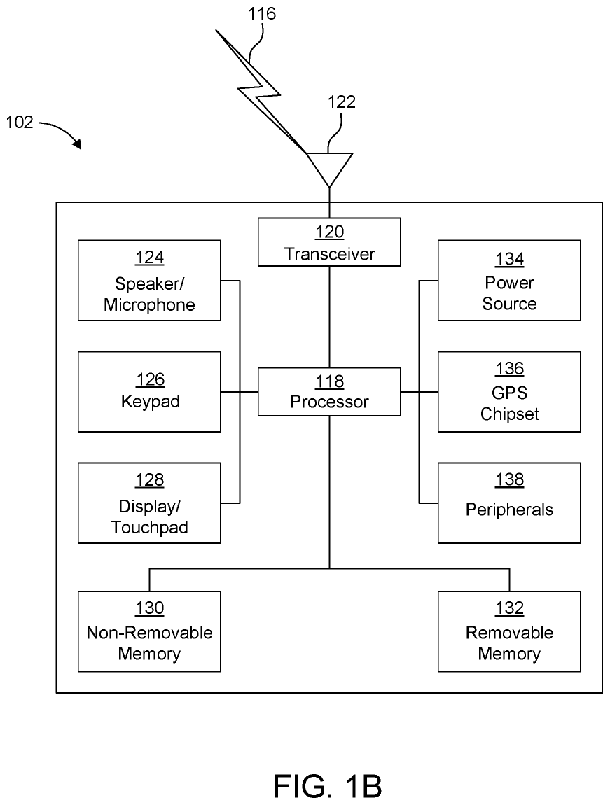

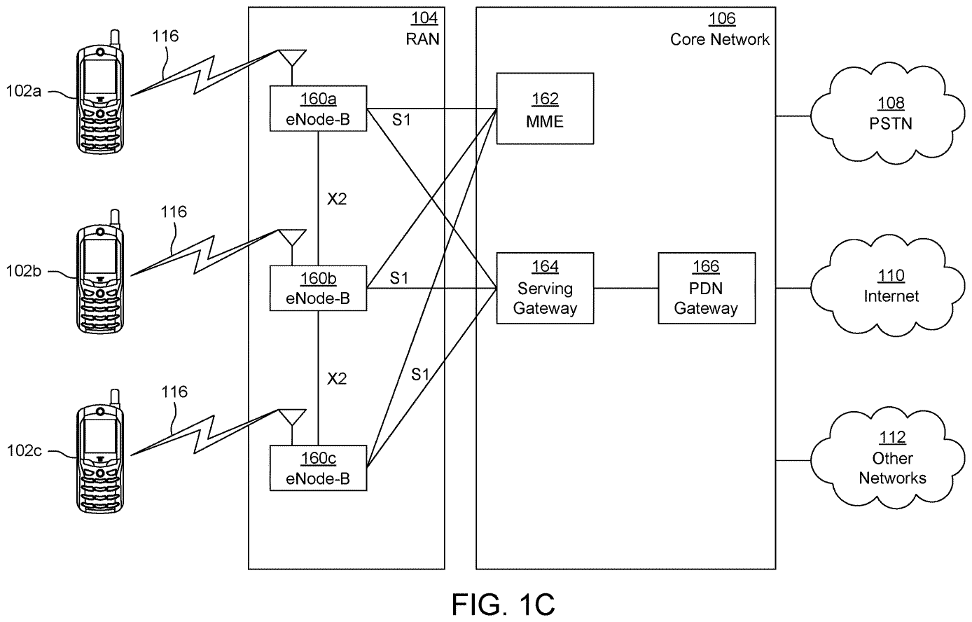

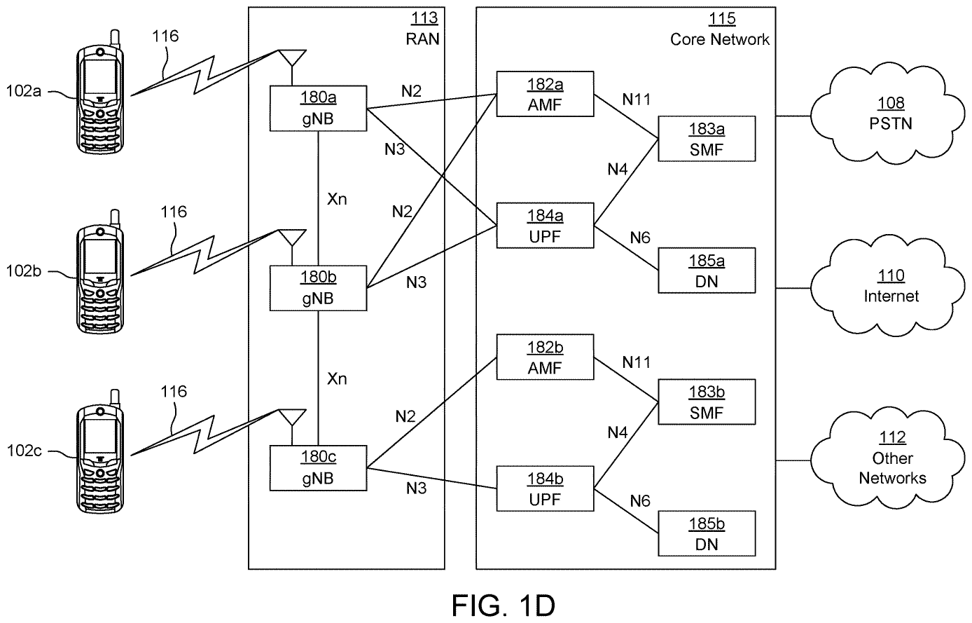

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

### Measurements

In RRC_CONNECTED, a WTRU 102 may measure one or more beams of multiple beams of a cell. A WTRU 102 may average the measurements results (e.g., power values) to derive (e.g., determine) a cell quality corresponding to the cell. For example, a WTRU 102 may be configured to consider a subset of the detected beams. Filtering may be performed at two different levels, at the physical layer to derive beam quality and then at the RRC layer to derive cell quality from multiple beams. Cell quality from beam measurements may be derived in the same way for a serving cell(s) and for a non-serving cell(s). Measurement reports may contain the measurement results of the X best beams, such as where a WTRU 102 has been configured to do so by a gNB 180.

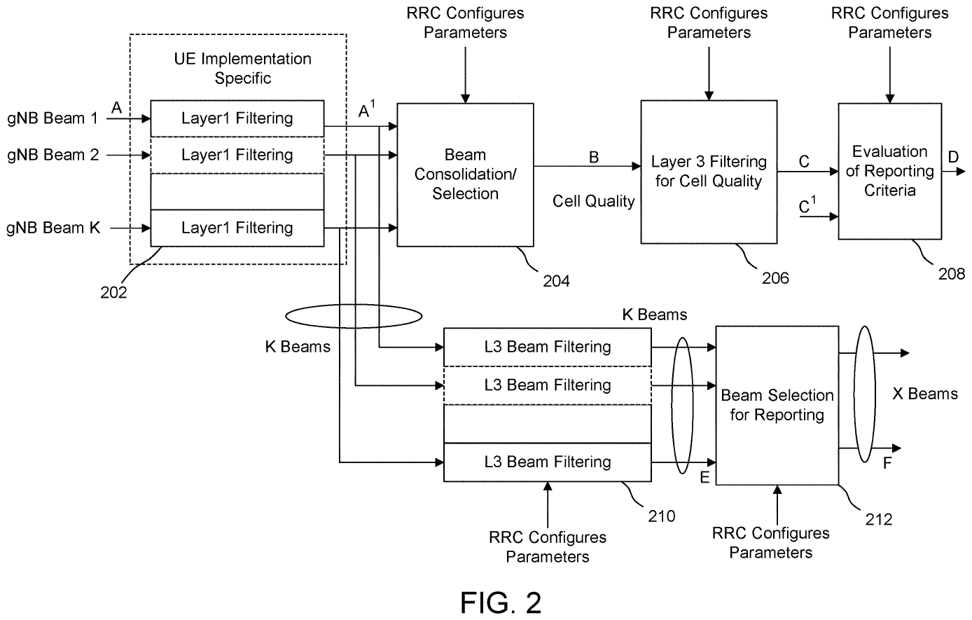

FIG. 2 is a block diagram illustrating an example of a measurement model. At A in FIG. 2, a WTRU 102 may perform one or more measurements (e.g., beam specific samples) internal to the physical layer. At the L1 filtering block 202, the WTRU 102 may perform internal L1 filtering of the inputs measured at A. For example, filtering may differ depending on implementation. Exact filtering may be implementation dependent. Performance of the measurements at the physical layer by an implementation (e.g., inputs A and L1 filtering) may not be constrained by standardization.

At A¹ in FIG. 2, the measurements (e.g., beam specific measurements) may be reported from layer 1 to layer 3 after the layer 1 filtering. At the Beam Consolidation/Selection block 204, the WTRU 102 may consolidate the beam specific measurements to derive cell quality information for the corresponding cell. The behavior of the beam consolidation/selection may be standardized. For example, RRC signaling may configure parameters associated with the beam consolidation/selection.

At B in FIG. 2, measurement information (e.g., cell quality) derived from the beam-specific measurements may be reported to layer 3 after the beam consolidation/selection block 204. For example, a reporting period at B may correspond to (e.g., equal) one measurement period at A¹. At the layer 3 filtering for cell quality block 206, the WTRU 102 may perform filtering on the measurements provided at B. For example, the behavior of the layer 3 filters may be standardized. For example, RRC signaling may configure parameters associated with the layer 3 filtering.

At C in FIG. 2, a measurement after processing in the layer 3 filtering block 206 may be provided. The measurement may used as input for one or more evaluation of reporting criteria. For example, a filtering reporting period at C may correspond to (e.g., equal) one measurement period at B. The filtering reporting rate at C may correspond to (e.g., equal) the rate at B. At the Evaluation of reporting criteria block 208, the WTRU 102 may check whether actual measurement reporting is necessary. The evaluation may be based on more than one flow of measurements at reference point C (e.g. to compare between different measurements). In FIG. 2, this is illustrated by inputs C and C¹. The WTRU 102 may (e.g., shall) evaluate the reporting criteria at least every time a new measurement result is reported at point C and/or C¹. The reporting criteria may be standardized. For example, RRC signaling may configure parameters associated with the evaluation of reporting criteria.

At D in FIG. 2, the WTRU 102 may send measurement report information (e.g., in a message) on a radio interface to a network, such as to a gNB 180.

At the L3 Beam filtering block 210 in FIG. 2, the WTRU 102 may perform filtering on the measurements (e.g., beam specific measurements) provided at point A¹. For example, the behavior of the beam filters may be standardized. For example, RRC signaling may configure parameters associated with the configuration of the beam filters.

At E in FIG. 2, a measurement (e.g., beam-specific measurement) after processing in the L3 beam filtering block 210 may be provided. For example, the measurement may be used as input for selecting X measurements to be reported. For example, a filtering reporting period at E may correspond to (e.g., equal) one measurement period at A¹. The filtering reporting rate may be identical to the reporting rate at point A¹.

At the Beam Selection for beam reporting block 212, the WTRU 102 may select X measurements from the measurements provided at E. The behavior of the beam selection may be standardized. For example, RRC signaling may configure parameters associated with the beam selection.

At F in FIG. 2, the WTRU may send beam measurement information (e.g., in a beam measurement report) on a radio interface to the network, such as to a gNB 180.

For example, the Layer 1 filtering may introduce (e.g., include) a certain level of measurement averaging. How and when the WTRU 102 exactly performs the required measurements may be implementation specific to the point that the output at B fulfils the performance requirements specified in TS 38.133. Layer 3 filtering for cell quality and related parameters used are specified in TS 38.331 and may not introduce any delay in the sample availability between B and C. In FIG. 2, C¹ is the input used in the event evaluation. L3 Beam filtering and related parameters used are specified in TS 38.331 and may not introduce any delay in the sample availability between E and F.

For example, a measurement report may include a measurement identity of an associated measurement configuration that triggered the reporting. A measurement report may include cell and/or beam measurement quantities which are configured by the network. A number of non-serving cells to be reported may be limited through configuration by the network. Cells belonging to an exclude-list configured by the network may not be used in event evaluation and reporting. Cells belonging to an allow-list may be configured by the network. For example, (e.g., only) the cells belonging to the allow-list may be used in event evaluation and reporting. Beam measurements to be included in a measurement report may be configured by the network (e.g., beam identifier only, measurement result and beam identifier, or no beam reporting).

For example, intra-frequency neighbour (e.g., cell) measurements and inter-frequency neighbour (e.g., cell) measurements may include synchronization signal block (SSB) based measurements and/or channel state information reference signal (CSI-RS) based intra-frequency measurement. For example, a SSB-based intra-frequency measurement may refer to an SSB-based intra-frequency measurement where a center frequency of the SSB of the serving cell and a center frequency of the SSB of the neighbour cell are the same and/or where the subcarrier spacing of the two SSBs are the same. For example, a SSB-based inter-frequency measurement may refer to an SSB-based intra-frequency measurement where a center frequency of the SSB of the serving cell and the center frequency of the SSB of the neighbour cell are different, and/or the subcarrier spacing of the two SSBs are different. For SSB-based measurements, one measurement object may correspond to one SSB and the WTRU 102 considers different SSBs as different cells.

For example, a CSI-RS based intra-frequency measurement may refer to as a measurement where a subcarrier spacing (SCS) of CSI-RS resources on a neighbour cell configured for measurement is the same as the SCS of CSI-RS resources on the serving cell indicated for measurement. For example, with a 60 KHz subcarrier spacing, the CP type of CSI-RS resources on a neighbour cell configured for measurement may be the same as the CP type of CSI-RS resources on the serving cell indicated for measurement. For example, a CSI-RS based intra-frequency measurement may refer to as a measurement where a center frequency of CSI-RS resources on the neighbour cell configured for measurement is the same as the center frequency of CSI-RS resources on the serving cell indicated for measurement.

For example, a CSI-RS based inter-frequency measurement may refer to as a measurement (e.g., using CSI-RS resources) other than a CSI-RS based intra-frequency measurement. For example, an extended CP may (or may not) be supported for CSI-RS based measurement.

For example, a measurement may be referred to as non-gap-assisted or gap-assisted depending on WTRU capability, an active BWP of the WTRU and/or an (e.g., current) operating frequency. For SSB based inter-frequency measurement, where the measurement gap requirement information is reported by the WTRU 102, a measurement gap configuration may be provided according to the information. Otherwise, a measurement gap configuration may (e.g., always) be provided in the following cases: the WTRU only supports per-WTRU measurement gaps, and/or the WTRU supports per-FR measurement gaps and any of the serving cells are in the same frequency range of the measurement object. For SSB based intra-frequency measurement, where the measurement gap requirement information is reported by the WTRU, a measurement gap configuration may be provided according to the information. Otherwise, a measurement gap configuration may (e.g., always) be provided in the following case: any configured BWPs (e.g., other than an initial BWP) do not contain the frequency domain resources of the SSB associated to the initial DL BWP.

In non-gap-assisted examples, a WTRU 102 may (e.g., shall) be able to carry out such measurements without measurement gaps. In gap-assisted scenarios, a WTRU 102 may not (e.g., cannot) be assumed to be able to carry out such measurements without measurement gaps.

### Inter-Cell L1/L2 Triggered Mobility (LTM)

Currently, 5G NR Release 17 (R17) can use inter-cell beam management which can manage the beams in carrier aggregation (CA) case, but no cell changes and/or additions are supported. In 5G NR Release 18 (R18), one of the objectives of the work item “Further NR Mobility Enhancements” in RP-213565 is to specify mechanisms and procedures of L1/L2 based inter-cell mobility for mobility latency reduction as shown below:
1. To specify mechanism and procedures of L1/L2 based inter-cell mobility for mobility latency reduction:
   Configuration and maintenance for multiple candidate cells to allow fast application of configurations for candidate cells [RAN2, RAN3]
   Dynamic switch mechanism among candidate serving cells (including SpCell and SCell) for the potential applicable scenarios based on L1/L2 signalling [RAN2, RAN1]
   L1 enhancements for inter-cell beam management, including L1 measurement and reporting, and beam indication [RAN1, RAN2]
      Note 1: Early RAN2 involvement is necessary, including the possibility of further clarifying the interaction between this bullet with the previous bullet
   Timing Advance management [RAN1, RAN2]
   CU-DU interface signaling to support L1/L2 mobility, if needed [RAN3]
Note 2: FR2 specific enhancements are not precluded, if any.
Note 3: The procedure of L1/L2 based inter-cell mobility are applicable to the following scenarios:
   Standalone, CA and NR-DC case with serving cell change within one CG Intra-DU case and intra-CU inter-DU case (applicable for Standalone and CA: no new RAN interfaces are expected).
   Both intra-frequency and inter-frequency
   Both FR1 and FR2
   Source and target cells may be synchronized or non-synchronized
   Inter-CU case is not included.

L1/L2 based mobility was originally started in R17 and inter-cell beam management in R17 addresses intra-DU and intra-frequency scenarios. In this case, a serving cell may remain unchanged (e.g., there is no possibility to change the serving cell using L1/2 based mobility). In FR2 deployments, CA is typically used in order to exploit the available bandwidth, such as to aggregate multiple component carriers (CCs) in one band. The CCs are typically transmitted with a same analog beam pair (e.g., gNB beam and WTRU beam). A WTRU 102 may be configured with TCI states (e.g., 64 TCI states) for reception of PDCCH and PDSCH. Each TCI state may include a RS or SSB that the WTRU 102 refers to for setting its beam. For R17, a SSB may be associated with a non-serving physical cell ID (PCI). MAC signaling (e.g., “TCI state indication for UE-specific PDCCH MAC CE”) activates the TCI state for a Coreset/PDCCH. Reception of PDCCH from a non-serving cell is supported by MAC CE indicating a TCI state associated to a non-serving PCI. MAC signaling (e.g., “TCI States Activation/Deactivation for UE-specific PDSCH”) activates a subset of up to 8 TCI states for PDSCH reception. DCI indicates which of the 8 TCI states. R17 also supports a “unified TCI state” with a different updating mechanism (e.g., DCI-based), but without multi-TRP. R18 is expected to support a unified TCI state with multi-TRP.

The overall objective of LTM is to improve handover latency. With a legacy L3 handover (HO) or conditional handover (CHO), a WTRU 102 may typically first send a measurement report using RRC signaling. In response to this, the network may provide a further measurement configuration and potentially a conditional handover configuration. With a legacy L3 handover, the network provides a configuration for a target cell after the WTRU 102 reports using RRC signaling that the cell meets a configured radio quality criteria. With a legacy conditional handover, in order to reduce the handover failure rate due to the delay in sending a measurement report then receiving a RRC reconfiguration, the network provides, in advance, a target cell configuration as well as measurement criteria which determines when the WTRU 102 should trigger the CHO configuration. Both of these L3 handover methods, however, do suffer from some amount of delay due to the sending of measurement reports and receiving of target configurations, particularly in the case of non-conditional handover.

One of the aims of LTM is to allow a fast application of configurations for candidate cells, including dynamically switching between SCells and switching of the PCell (e.g. switch the roles between SCell and PCell) without performing RRC signalling. An inter-centralized unit (CU) case is not included, as this requires relocation of the PDCP anchor and has already been excluded from the work item. Therefore, an RRC based approach is needed at least to support inter-CU handover.

Furthermore, with the legacy L3 handover mechanisms, any currently active SCell(s) are released before the WTRU 102 moves to complete the handover to a target cell in the coverage area of a new site. The Scells can only be added back after successful handover, which leads to throughput degradation during handover. One of the aims of L1/2 is therefore to enable CA operation to be enabled instantaneously upon serving cell change.

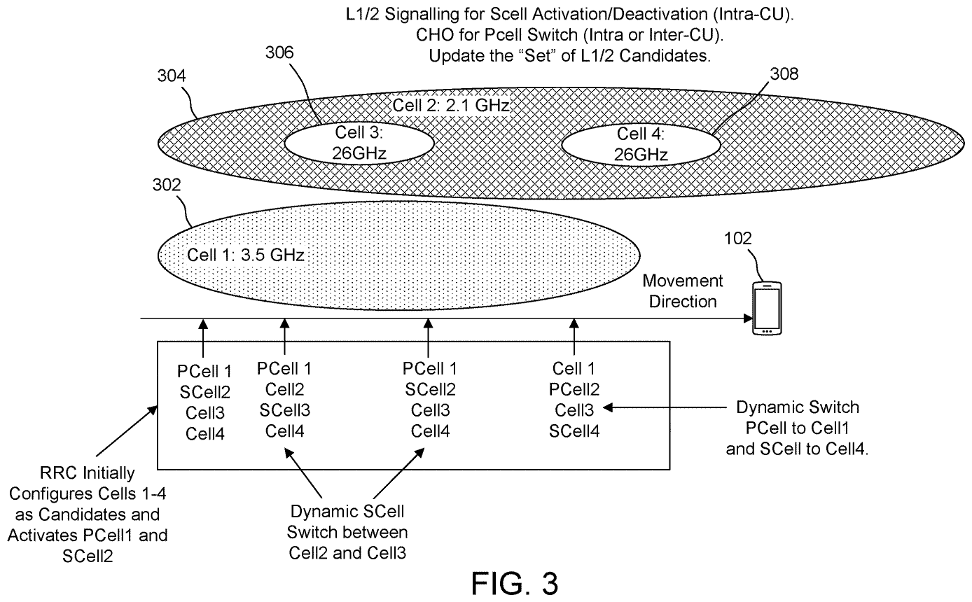

FIG. 3 is a system diagram illustrating an example of LTM operation. A candidate cell group may be configured by RRC. A dynamic switch of PCell and SCell may be achieved by the WTRU 102 using L1/2 signalling.

In FIG. 3, RRC signaling may configure a WTRU 102 with cells 1, 2, 3 and 4 as a candidate cell group. By way of example only, cell 1 302 may be operating at 3.5 GHZ, cell 2 304 may be operating at 2.1 GHz, cell 3 306 may be operating at 26 GHZ, and/or cell 4 308 may be operating at 26 HZ. Cell 1 302 may be activated as a Pcell. Cell 2 304 may be activated as a Scell. The WTRU 102 may perform dynamic Scell switching between cell 2 304, cell 3 306, and/or cell 4 308 (e.g., during mobility). The WTRU 102 may perform dynamic Pcell switching between cell 1 302 and cell 2 304 (e.g., during mobility).

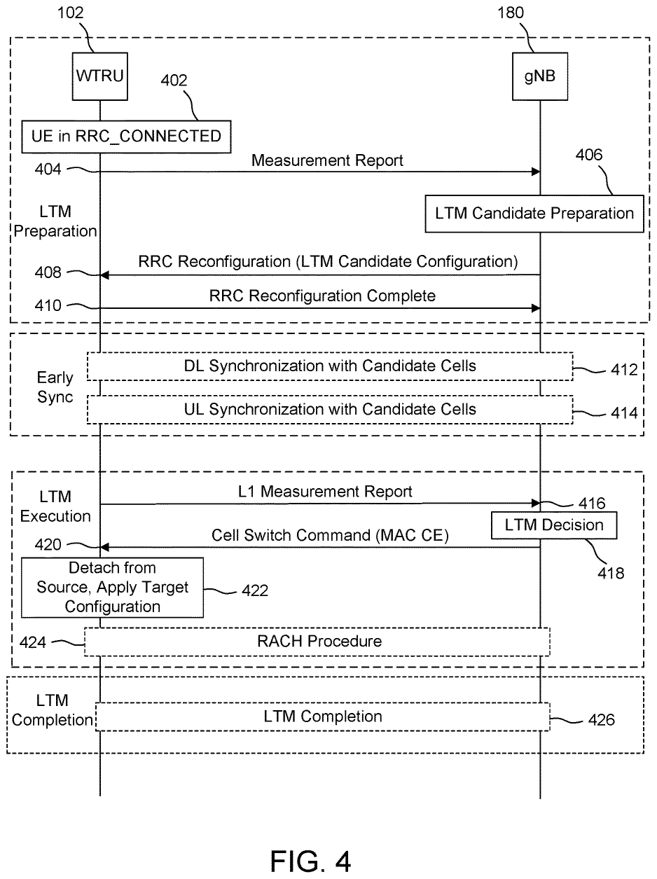

In March 2023, RAN Working Group 2 (RAN2) endorsed a baseline procedure for LTM. FIG. 4 is a procedural diagram illustrating a baseline procedure for LTM. At 402, a WTRU 102 may be in a RRC Connected state with the network (e.g., gNB 180). At 404 in FIG. 4, a WTRU 102 may send a MeasurementReport message to a gNB 180. The gNB 180 may determine to use LTM and may initiates candidate cell(s) preparation.

At 406, the gNB 180 may prepare LTM candidate cell configurations, and at 408 the gNB 180 may transmit a RRCReconfiguration message to the WTRU 102 including the LTM candidate cell configurations of one or more candidate cells.

At 410, the WTRU 102 stores the LTM candidate cell configurations and may transmit a RRCReconfigurationComplete message to the gNB.

At 412, the WTRU 102 may perform DL synchronization and/or timing advance (TA) acquisition with candidate cell(s) before receiving a cell switch command. For example, DL synchronization for candidate cell(s) before the cell switch command may be based (e.g., at least) on SSB. For example, TA acquisition of candidate cell(s) before the LTM cell switch command may be based (e.g., at least) on a PDCCH ordered RACH, where the PDCCH order is only triggered by a source cell. At 414, the WTRU 102 may perform UL synchronization with candidate cell(s) before receiving a cell switch command.

At 416, the WTRU 102 may perform L1 measurements on the configured candidate cell(s), and may transmit (e.g., report) lower-layer measurements to the gNB. For example, lower-layer measurement reports may be carried on L1 or MAC. For example, the order of DL synchronization, UL synchronization, and/or L1 measurement reporting (e.g., 412, 414, 416 in FIG. 4) may be changed and/or modified.

At 418, the gNB 180 may make an LTM decision and at 420 may determine to execute a cell switch to a target cell. At 420, the gNB 180 may transmit a MAC CE triggering the cell switch. For example, the gNB 180 may include information indicating the candidate configuration index of the target cell. At 422, the WTRU 102 may switch to the configuration of the target cell. For example, the gNB 180 may provide information indicating one or more beams of the target cell.

At 424, the WTRU 102 may perform a random access procedure towards the target cell, such as where required by the cell switch.

At 426, the WTRU 102 may indicate successful completion of the cell switch towards the target cell. For example, the WTRU 102 may send an uplink signal and/or message to indicate successful completion of the LTM cell switch to the target cell.

For example, a WTRU 102 may perform 412 through 426 one or more times for subsequent LTM cell switches based on the configuration provided at 408.

As mentioned above, an inter-CU switch case is not included, as this requires relocation of the PDCP anchor and has already been excluded from the work item. Therefore, an RRC-based approach may be provided to support inter-CU handover, such as for the DU/CU split architectures. For example, inter-CU handover procedures may be used with LTM procedures for intra-CU, intra-DU and/or inter-DU switching. For example, when LTM is configured, along with measurement and measurement reporting mechanisms to support LTM, RRC based measurements and mobility may be performed in parallel with the measurement and measurement reporting mechanisms to support LTM.

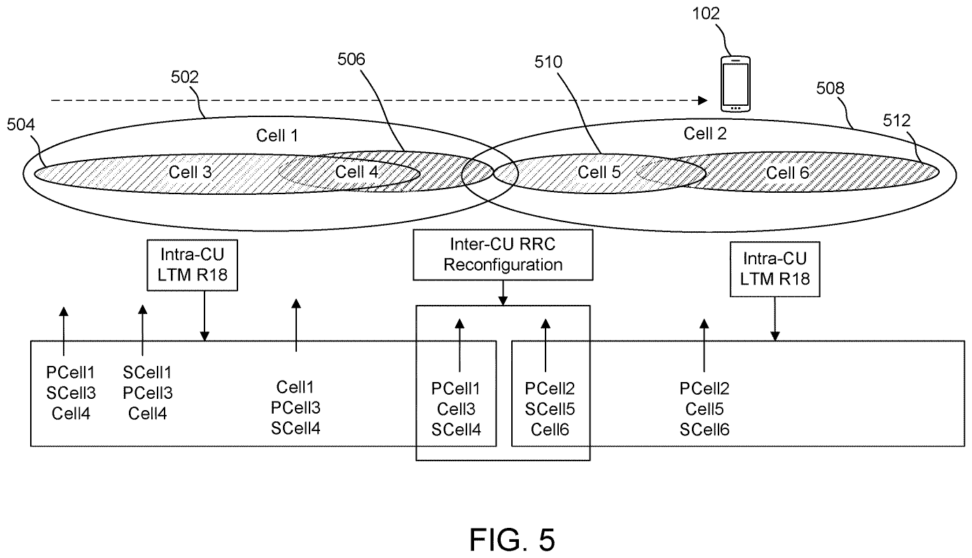

FIG. 5 is a system diagram illustrating examples of intra-CU and inter-CU switching. By way of example only, LTM may used for mobility amongst cell 1 502, cell 3 504, and cell 4 506 which belong to a first CU, and LTM may be used for mobility amongst cell 2 508, cell 5 510, and cell 6 512 which belong to a second CU. L3 mobility may be used for mobility between cells belonging to the first and second DU, for example for handover from the cell 1 502 to the cell 2 508 (e.g., measurement reporting and RRC reconfiguration, and/or conditional reconfiguration (CHO).

For example, LTM may use L1 measurement reporting, and a MAC CE trigger to perform the reconfiguration (handover). For example, L3 mobility may use L3 measurements and a RRC trigger for reconfiguration. The latency of L1 measurements and MAC triggering may be expected to be significantly less than L3 measurements and RRC triggering, for several reasons. First, the measurement filtering performed at L1 may be done over a shorter timescale than the measurement filtering performed at L3, and the measurement event evaluation at L1 may be expected to be performed over a shorter timescale than the L3 measurement evaluation which uses a relatively longer time-to-trigger. L3 measurement evaluation may be performed using a longer filtering and longer time-to-trigger because a handover using L3 signaling is relatively expensive in terms of overhead, and service interruption should be performed only when necessary—the time-to-trigger and filtering is designed to reduce the possibility of ping-ponging between cells and to ensure a stable target cell measurement before executing handover. L1 mobility implies a lower cost in terms of overhead and service interruption due to the use of preconfigured cell configurations, faster handover execution times, and further enhancements such as avoiding a full MAC reset when performing intra-DU handover, and performing UL and DL synchronization prior to executing the cell change. Therefore, the measurements can be performed more quickly to improve latency and handover failure/radio link failure rates, at the cost of higher ping-pong rates, which as explained, have a smaller cost than with L3 mobility. Hence, any changes in cell quality may be detected earlier at L1 than at L3.

Secondly, LTM may be under the control of the DU (e.g., the source DU in cases of inter-DU mobility) while L3 mobility (e.g., RRC) is controlled by the CU. RRC signaling between the WTRU 102 and the CU may be slower compared to L1/L2 signaling between the WTRU 102 and the DU. The RRC signaling may be transmitted via the DU using the L1/2 protocol layers, and the MAC/L1 signaling may be terminated at the DU. RRC signaling may be more reliable than using (e.g., only) L2 due to the use of RRC acknowledgements (e.g. RRC Reconfiguration Complete), RLC AM (e.g., ARQ), and MAC (e.g., HARQ). The multiple levels of acknowledgement imply further latency and delay.

For these reasons, a number of potential race conditions exist when LTM is configured. Race conditions may refer to conditions that exist between different measurement and reporting types and/or between different handover trigger signaling mechanisms. Issues include any of (1) premature mobility outside of a LTM area, (2) delayed and/or blocked mobility outside of a LTM area, (3) a race condition where a WTRU 102 receives signaling for both L3 mobility and L1/2 mobility, and/or (4) a race condition where a WTRU 102 triggered a L3 measurement report and, before successful delivery of the L3 report, a L2 mobility procedure is executed.

As for premature mobility outside a LTM area, in certain scenarios, a L3 measurement event may be triggered based on a comparison of a current serving cell with a neighbor cell even if there are configured LTM candidates which are suitable.

As for delayed or blocked mobility outside LTM area, in certain scenarios, a L3 measurement event may be prevented from being triggered, since frequent L2 triggered handovers may reset the L3 measurement evaluation.

Further, a race condition may exist where a WTRU 102 receives signaling for (e.g., both) L3 mobility, which may be controlled by a CU, and L1 and/or L2 mobility, which may be controlled by a DU.

Further, a race condition may exist where a WTRU 102 has triggered a L3 measurement report. Before the WTRU 102 has successfully delivered the L3 report, a L2 mobility procedure is executed.

### Overview

Abbreviations and Acronyms
The following abbreviations and acronyms may be used herein.

| | |
|---|---|
| ACK | Acknowledgement |
| BLER | Block Error Rate |
| BWP | Bandwidth Part |
| CA | Carrier aggregation |
| CAP | Channel Access Priority |
| CAPC | Channel access priority class |
| CCA | Clear Channel Assessment |
| CCE | Control Channel Element |
| CE | Control Element |
| CG | Configured grant or cell group |
| CHO | Conditional handover |
| CP | Cyclic Prefix |
| CP-OFDM | Conventional OFDM (relying on cyclic prefix) |
| CPA | Conditional PsCell addition |
| CPAC | Conditional PsCell addition/change |
| CPC | Conditional PsCell change |
| CQI | Channel Quality Indicator |
| CRC | Cyclic Redundancy Check |
| CSI | Channel State Information |
| CW | Contention Window |
| CWS | Contention Window Size |
| CO | Channel Occupancy |
| DAI | Downlink Assignment Index |
| DO | Dual connectivity |
| DCI | Downlink Control Information |
| DFI | Downlink feedback information |
| DG | Dynamic grant |
| DL | Downlink |
| DM-RS | Demodulation Reference Signal |
| DRB | Data Radio Bearer |
| eLAA | enhanced Licensed Assisted Access |
| FeLAA | Further enhanced Licensed Assisted Access |
| HARQ | Hybrid Automatic Repeat Request |
| LAA | License Assisted Access |
| LBT | Listen-Before-Talk |
| LTE | Long Term Evolution e.g. from 3GPP LTE R8 and |
| LTM | L1/2 triggered mobility |
| NACK | Negative ACK |
| MCG | Master cell group |
| MAC | Medium access control |
| MCS | Modulation and Coding Scheme |
| MIMO | Multiple Input Multiple Output |
| NR | New Radio |
| OFDM | Orthogonal Frequency-Division Multiplexing |
| PCell | Primary cell |
| PCI | Physical cell identity |
| PHY | Physical Layer |
| PID | Process ID |
| PO | Paging Occasion |
| PRACH | Physical Random Access Channel |
| PSCell | Primary SCG Cell |
| PSS | Primary Synchronization Signal |
| RA | Random Access (or procedure) |
| RACH | Random Access Channel |
| RAR | Random Access Response |
| RCU | Radio access network Central Unit |
| RF | Radio Front end |
| RLC | Radio Link Control |
| RLF | Radio Link Failure |
| RLM | Radio Link Monitoring |
| RNTI | Radio Network Identifier |
| RO | RACH occasion |
| RRC | Radio Resource Control |
| RRM | Radio Resource Management |
| RS | Reference Signal |
| RSRP | Reference Signal Received Power |
| RSSI | Received Signal Strength Indicator |
| SCell | Secondary cell |
| SCG | Secondary cell group |
| SDU | Service Data Unit |
| SpCell | Special Cell |
| SRS | Sounding Reference Signal |
| SS | Synchronization Signal |
| SSS | Secondary Synchronization Signal |
| SWG | Switching Gap (in a self-contained subframe) |
| SPS | Semi-persistent scheduling |
| SUL | Supplemental Uplink |
| TB | Transport Block |
| TBS | Transport Block Size |
| TRP | Transmission/Reception Point |
| TSC | Time-sensitive communications |
| TSN | Time-sensitive networking |
| UL | Uplink |
| URLLC | Ultra-Reliable and Low Latency Communications |
| WBWP | Wide Bandwidth Part |
| WLAN | Wireless Local Area Networks and related |
| | technologies (IEEE 802.xx domain) |

As used herein, the term SpCell may refer to any of a PCell of a MCG and/or a PSCell of a SCG (e.g., depending on whether a MAC entity is associated to the MCG or the SCG).

In certain representative embodiments, a LTM virtual cell quality may be determined (e.g., derived) from a plurality of LTM candidate cells. For example, it may be possible to avoid premature mobility outside an LTM area, such as due to a (e.g. temporary) radio link quality issue in a serving cell while other candidate cells within the LTM area would be acceptable. In other words, a WTRU 102 may perform procedures to identify whether it is worthwhile (e.g., efficient) to undergo a L3 switch to a cell outside of LTM (e.g., compare an LTM set to a cell outside the set using a L3 filter) or switch to a separate LTM set (e.g., compare LTM sets).

In certain representative embodiments, a L3 cell quality may be determined for a virtual cell utilizing beams from a subset or all of the cells of an LTM candidate set. A virtual cell quality derivation (e.g., procedure) may refer to a modified cell quality derivation where the beams from different cells within an LTM candidate set can be considered to derive the LTM candidate set's virtual cell quality. A virtual cell quality of a source LTM candidate set may be used as a source cell's quality or used to determine an offset to apply to (e.g., on top of) the source cell's quality. A virtual cell quality of a target LTM candidate set (e.g., a set of neighbor cells) may be used as a target cell's quality or used to determine an offset to apply to (e.g., on top of) the target cell's quality. A WTRU 102 may report measurement information using a virtual cell quality, such as under a condition that a (e.g., maximum or minimum) time period has elapsed since a (e.g., last) LTM cell switch.

For example, a WTRU 102 may average over a first (e.g., larger) set of cells and/or beams just after cell switch and later use a second (e.g., smaller) set of cells and/or beams, such as only a source cell or best candidate cell. This may ensure that the WTRU 102 can eventually switch to a better LTM set.

In an example embodiment, a WTRU 102 may receive information indicating a configuration associated with the determination of (e.g., how to derive) a quality for an LTM set. The determined quality may consider beams on all or a subset of the cells within the LTM set. For example, the configuration may include information indicating any of: a maximum/minimum number of cells to include in the derivation; a maximum/minimum number of beams to include in the derivation; a minimum quality of the beams/cells to be included in the derivation (e.g., absolute/relative to serving cell, absolute/relative to the best cell); one or more averaging/filtering weights to apply for the derivation; one or more offsets and/or scaling parameters to apply to the derivation; a list of cells and/or beams that must be included in the derivation; a list of cells and/or beams that may not be included in the derivation; an association of each serving beam with a list of beams on other cells to include in the virtual cell quality derivation; an indication to use the derived LTM set quality as the source and/or target cell's quality; and/or an indication to use the derived LTM set quality as an offset to be applied to (e.g., on top of) the source and/or target cell's quality.

The WTRU 102 may receive information indicating a configuration for L1 and/or L3 measurement events. For example, a triggering condition for the events may be based on the comparison of at least one LTM set quality (e.g., a serving LTM set, a target LTM set) with one or more of the following: another LTM set quality; an individual cell quality (e.g., serving cell outside an LTM set, target cell outside an LTM set); a cell quality threshold; a maximum time since last LTM cell switch; and/or a minimum time since last LTM cell switch.

The WTRU 102 may determine the cells and/or beams to consider for the LTM set quality derivation (e.g., based on the above configurations for the serving LTM set and/or target LTM set).

The WTRU 102 may perform the measurements and derive the LTM set quality for the source LTM set and/or target LTM set.

The WTRU 102 may use (e.g., based on the above configurations) the derived LTM set quality as the source and/or target cell quality. The WTRU 102 may apply (e.g., based on the above configurations) the derived LTM set quality to the serving and/or target cell quality (e.g., as an offset, scaling factor, etc.).

The WTRU 102 may determine that one or more of the triggering conditions for the event are fulfilled, such as a minimum time period has elapsed since a last LTM cell switch, and perform one or more of the following: send a measurement report associated with the event (e.g., including one or more derived LTM set qualities, details of cells and/or beams used for that derivation, legacy cell and/or beam measurement results); perform an associated conditional reconfiguration (e.g., if configured); and/or send an indication about the execution of the conditional reconfiguration (e.g., including one or more derived LTM set qualities, details of cells and/or beams used for that derivation, legacy cell and/or beam measurement results).

In certain representative embodiments, long term measurement evaluation may be performed across multiple LTM serving cells. For example, a network may want to configure a relatively long time-to-trigger (TTT) value for one or more L3 measurement events to prevent premature switching out of the LTM set. Side effects may include that a WTRU 102 switches frequently (e.g., more often than every TTT) between cells using LTM, and/or a L3 measurement event may trigger too late (or never) because the serving cell of the WTRU 102 changes within the TTT. A trigger condition may be enhanced to allow considering all serving cells within the TTT, such as when a candidate cell is much better than a current serving cell.

For example, when a WTRU 102 switches from a first serving cell to a second serving cell using LTM, the WTRU 102 may derive a L3 cell quality and evaluates a L3 event trigger based on measurement results applicable to first and second serving cells (e.g., as if the serving cells were a single serving cell). The WTRU 102 may continue evaluation of the (e.g., current) serving cell quality and the measurement event trigger after a cell change. After the cell change, the WTRU 102 may (e.g., continue to) use the previous serving cell(s) measurements as if they were current cell measurements. A WTRU 102 may trigger a measurement report where at least one condition is satisfied for the current serving cell (e.g., evaluated using first and second serving cell) over the TTT duration. A WTRU 102 may perform the foregoing under a condition that the measurement result for the candidate cell is above a threshold; otherwise, the WTRU 102 may (e.g., only) trigger where the condition is satisfied over TTT for the current serving cell. For example, a L3 filtered result of a second serving cell may be based on a L3 filtered result of a first serving cell at the time of cell switch.

In an example embodiment, a WTRU may receive information indicating a configuration associated with the determination of (e.g., how to derive) a serving cell quality using L3 filtering taking L1 RSRP, RSRQ, and/or SINR samples from any cell which has been a Pcell within a filtering window For example, the configuration may include information indicating at least one of a filter coefficient, a RS type, and/or a RS index.

For example, the WTRU 102 may receive information indicating a configuration for L1 and/or L3 measurement events. A configuration may include information indicating that evaluation over a TTT (e.g., period, duration, interval) is performed using measurement results of any cell which has been a serving cell while the TTT is running (e.g., during the TTT), and/or a threshold for the neighbor cell measurement result.

For example, the WTRU 102 may determine that a condition for an event is met over a first time period for a first serving cell and a neighbor cell. The first time period may be lower (e.g., shorter) than the TTT.

For example, the WTRU 102 may receive information indicating to switch from a first serving cell to second serving cell using LTM at the end of (or no later than) a first time period.

For example, the WTRU 102 may determine that a condition for the event is met over a second time period for a second serving cell and the neighbor cell. The sum of the first and second time periods may be equal to or greater than the TTT. Under a condition that a result of the neighbor cell is above the result of the second serving cell plus the threshold, the WTRU 102 may trigger transmission of a measurement report including information indicating the first and/or second serving cells, and/or the first and/or second time periods.

In certain representative embodiments, a prohibition on a timer for LTM measurement reporting after a L3 handover procedure may be applied. For example, a timer on L1 reporting may be prohibited after a L3 cell switch to (e.g., temporarily) restrict reporting. Example prohibitions described herein may address the race conditions where a L3 handover is completed but LTM handover occurs before the L3 signaling (e.g., RRC Reconfiguration complete transmission using RLC AM) is completed. This may occur for a L3 handover including an LTM set in the target configuration, may also occur on initial LTM setup (e.g., a LTM cell switch happens before delivery of RRC reconfiguration complete corresponding to LTM setup is complete).

To provide for RRC Reconfiguration complete signaling to be successfully delivered (e.g., to a CU) after L3 handover, a WTRU 102 may be prevented from sending L1 measurement reports and/or executing LTM which may result in DU triggered LTM handover and L3 signaling being lost, resulting in CU detecting a handover failure or reconfiguration failure. For example, a temporary restriction on neighbor and/or candidate cell L1 reporting (e.g., with current cell beam reporting still enabled to allow scheduling) may use a timer, or by waiting for RLC acknowledgement of the RRC message (e.g., complete) transmission. For example, a WTRU 102 may be caused to complete a L3 measurement evaluation, such as when LTM is prevented from occurring while a TTT period has not elapsed (e.g., TTT is running).

In an example embodiment, a WTRU 102 may receive a RRC reconfiguration message including information indicating an LTM measurement suspension and/or an associated timer value.

For example, the WTRU 102 may perform RRC reconfiguration and may stop LTM L1 measurement reporting on neighbor cells (e.g., if already running). The WTRU 102 may send a RRC reconfiguration complete message.

For example, under a condition that an amount of elapsed time since reception of the RRC reconfiguration is less than an indicated time amount (e.g., the timer value), and the WTRU 102 receives an LTM cell switch command, the WTRU 102 may transmit an indication (e.g., via MAC CE) that the cell switch is not executed. Where the LTM cell switch is received before timer expiry (e.g., elapsed time is less than the indicated time), the WTRU 102 may not execute the LTM cell switch command and may respond with a failure indication.

For example, under a condition that an amount of elapsed time since transmission or successful acknowledgement of the RRC reconfiguration complete message is less than indicated time amount (e.g., the timer value), and the WTRU 102 receives an LTM cell switch command, the WTRU 102 may transmit an indication (e.g., via MAC CE) that the cell switch is not executed. Where the LTM cell switch is received before timer expiry (e.g., elapsed time is less than the indicated time), the WTRU 102 may not execute the LTM cell switch command and may respond with a failure indication.

For example, when a time period corresponding to the indicated timer value has elapsed since reception of the RRC reconfiguration message, the WTRU 102 may start (or resume) LTM L1 measurement reporting for candidate cells.

For example, when a time period corresponding to the indicated timer value has elapsed since transmission of a RRC reconfiguration complete message, the WTRU 102 may start (or resume) LTM L1 measurement reporting for candidate cells.

### Common Terminology

As used herein, to perform LTM or performing LTM procedures may refer to performing any or all of the steps described in FIG. 4. For example, a WTRU 102 may perform LTM which includes early synchronization in DL and/or UL to one or more of the candidate cells, performing L1 measurements and reporting on one or more of the candidate cells, switching (e.g., performing handover) between candidate cells. As another example, a WTRU 102 may perform LTM which refers to a WTRU 102 moving and/or switching between multiple candidate cells during a procedure.

As used herein, a candidate cell set may refer to a group of RRC configurations corresponding to HO configurations for one or more candidate SpCells and/or SCells. One or more candidate cell sets may be groups of more than one RRC configuration corresponding to a HO configuration for one or more candidate SpCells and/or SCells. For example, a candidate cell set may be include and/or be used interchangeably with one or more complete RRC reconfiguration messages, one or more cell group configurations, and/or one or more cell configurations. A candidate cell configuration may include a candidate configuration identifier, and/or a candidate cell groups may include a candidate cell group identifier. For example, the grouping of candidate cells may be performed using RRC signalling. The switching between different sets of candidate cells may include updating the serving cell indices or candidate configuration indices which are used in L1 and MAC signalling to refer to specific indices. As an example, a MAC CE triggering a reconfiguration may include a candidate configuration index informing the WTRU 102 which cell to perform the reconfiguration to.

In certain representative embodiments, one or more candidate cell groups may be configured as a single list or group of candidate cell configurations using RRC. A grouping may occur at the early sync or LTM execution phase (e.g., rather than the configuration phase). A candidate cell set may be considered as a single group in terms of an RRC configuration list or group, while the cells selected for performing early sync, L1 measurements, and LTM execution may depend on a further grouping into multiple subsets of the overall candidate cell list. In other words, the grouping itself may not be modelled at RRC using candidate configuration identifiers, but the grouping may be executed as part of the early sync or the LTM execution procedure.

As used herein, an LTM candidate configuration may refer to any type of preconfigured cell information. For example, a WTRU 102 may be configured with one or more conditional reconfigurations, [such as a conditional handover (CHO), a conditional PSCell addition (CPA), and/or a conditional PSCell change (CPC) which are valid before and/or after a cell change, or valid in certain cells.

### Common Principles and Observations

### L1 Measurement

As used herein, a L1 measurement may refer to a measurement of any of RSRP, RSRQ, RSSI, and/or the similar values. A L1 measurement may be performed by a WTRU 102 on any of a cell, beam, set of cells, and/or set of beams. A L1 measurement may be similar to L3 measurements reported in RRM, with differences in the filtering, reference signals measured, reporting mechanisms.

In certain representative examples, including but not limited to the context of 3GPP standards, a L1 measurement may refer to measurements associated with points A and A¹ in FIG. 2.

### L3 Measurement

As used herein, a L3 measurement herein may refer to a measurement after processing in the L3 filter. In certain representative examples, including but not limited to the context of 3GPP standards, a L3 measurement may refer to measurements at point B in FIG. 2 (e.g., a cell quality measurement) derived from beam-specific measurements reported to layer 3 after beam consolidation/selection) or at point C in FIG. 2 (e.g., a measurement after processing in the layer 3 filter). For example, a reporting rate at C may be more or less the same (e.g., identical) to a reporting rate at point B. A L3 measurement may be used as input for one or more evaluation of reporting criteria.)

### General Measurement

As used herein, a L1 measurements may refer to L1 measurements for LTM, and a L3 measurements may refer to measurements performed in RRC, using specified L3 filtering and cell quality derivation. Some representative embodiments may be applied to L1 measurements and/or to RRM/L3 measurements, as well as other measurements (e.g., measurements of speed, location, height, traffic, etc.) or measurements obtained after an alternative processing (e.g., a different type of filtering or different type of averaging) or a different measurement quantity (e.g., RSRP, RSRQ, RSSI, CSI, etc.)

### Measurement Events

As used herein, a measurement event may refer to occurrences where measurements satisfy certain conditions. Some representative embodiments may include the use of measurement events as set forth in 3GPP TS 38.331 § 5.5.4 which include event A1 (Serving becomes better than threshold); event A2 (Serving becomes worse than threshold); event A3 (Neighbour becomes offset better than SpCell); event A4 (Neighbour becomes better than threshold); event A5 (SpCell becomes worse than threshold1 and neighbour becomes better than threshold2); and so forth as those skilled in the art are familiar with. Measurement events as described herein include the foregoing events but are not limited thereto.

### Common Benefits

In certain representative embodiments, multiple types of mobility, measurement, and reporting may be enabled to co-exist. For example, a WTRU 102 may perform a L1/2 triggered mobility procedure and a L3 triggered mobility procedure. Due to the nature of the procedures, race conditions may exist due to different measurement timings, different signalling latencies, different network nodes controlling the mobility, and/or different protocol layers handling the processing in the WTRU 102 and in the network. Hence, embodiments disclosed herein may enable interaction between different mobility types, and/or provide measures to reduce or eliminate potential problems which may arise due to race conditions between the procedures.

### LTM and Measurement Configuration

In certain representative embodiments, a configuration of LTM may include an RRC pre-configuration for multiple serving cells and/or a configuration of L1 measurements (e.g., CSI reporting, L1 event triggers) for use with LTM. For example, a WTRU 102 may be configured with L3 measurements for measurement reporting and/or a conditional reconfiguration (CHO).

In certain representative embodiments, a WTRU 102 may be configured with an association between the L1 measurements and the L3 measurements. For example, a WTRU 102 may be configured with information indicating which of the L1 measurement results may affect L3 measurement results. For example, in some cases specific measurement objects, measurement identities, and/or conditional reconfigurations can use specific CSI measurement reporting and/or resource configurations.

### Capability

In certain representative embodiments, a WTRU 102 may report capability information for specific functions (e.g., WTRU-specific capabilities), such as support for LTM, support for particular measurement derivation methods, and/or a maximum number of beams, cells, and/or carriers that can be measured using any particular measurement method. For example, capability information may include a performance indication, such as a number of RF receivers, a maximum bandwidth, a processing capability and/or timing information. A LTM and/or measurement capability may be reported per band or per band combination.

### Prohibit Timer for LTM Measurement Reporting After a L3 Handover Procedure

In certain representative embodiments, a prohibition on a timer for L1 reporting may be applied after a L3 cell switch to (e.g., temporarily) restrict reporting.

Example prohibitions described herein may address the race conditions where a L3 handover is completed but LTM handover occurs before the L3 signaling (e.g., RRC Reconfiguration complete transmission using RLC AM) is completed. This may occur for a L3 handover including an LTM set in the target configuration, may also occur on initial LTM setup (e.g., a LTM cell switch happens before delivery of RRC reconfiguration complete corresponding to LTM setup is complete).

To provide for RRC Reconfiguration complete signaling to be successfully delivered (e.g., to a CU) after L3 handover, a WTRU 102 may be prevented from sending L1 measurement reports and/or executing LTM which may result in DU triggered LTM handover and L3 signaling being lost, resulting in CU detecting a handover failure or reconfiguration failure. For example, a temporary restriction on neighbor and/or candidate cell L1 reporting (e.g., with current cell beam reporting still enabled to allow scheduling) may use a timer, or by waiting for RLC acknowledgement of the RRC message (e.g., complete) transmission.

In certain representative embodiments, a WTRU 102 may receive a RRC reconfiguration message including information indicating an LTM measurement suspension and/or an associated timer value.

For example, the WTRU 102 may perform RRC reconfiguration and may stop LTM L1 measurement reporting on neighbor cells (e.g., if already running). The WTRU 102 may send a RRC reconfiguration complete message.

For example, under a condition that an amount of elapsed time since reception of the RRC reconfiguration is less than an indicated time amount (e.g., the timer value), and the WTRU 102 receives an LTM cell switch command, the WTRU 102 may transmit an indication (e.g., via MAC CE) that the cell switch is not executed. Where the LTM cell switch is received before timer expiry (e.g., elapsed time is less than the indicated time), the WTRU 102 may not execute the LTM cell switch command and may respond with a failure indication.

For example, under a condition that an amount of elapsed time since transmission or successful acknowledgement of the RRC reconfiguration complete message is less than indicated time amount (e.g., the timer value), and the WTRU 102 receives an LTM cell switch command, the WTRU 102 may transmit an indication (e.g., via MAC CE) that the cell switch is not executed. Where the LTM cell switch is received before timer expiry (e.g., elapsed time is less than the indicated time), the WTRU 102 may not execute the LTM cell switch command and may respond with a failure indication.

For example, under a condition that a TTT is running (e.g., has started due to a condition being met, but has not yet expired) for a configured RRC Measurement event, and the WTRU 102 receives an LTM cell switch command, the WTRU 102 may transmit (e.g., via MAC CE) information indicating that the cell switch is not executed. Where the LTM cell switch is received while a TTT is running for a configured RRC Measurement event, the WTRU 102 may not execute the LTM cell switch command and may respond with a failure indication. For example, the TTT running may refer to where a time period corresponding to a TTT value has not elapsed. For example, the TTT expiring may refer to where a time period corresponding to the TTT value has elapsed.

For example, when a time period corresponding to the indicated timer value has elapsed since reception of the RRC reconfiguration message, the WTRU 102 may start (or resume) LTM L1 measurement reporting for candidate cells.

For example, when a time period corresponding to the indicated timer value has elapsed since transmission or successful acknowledgement of a RRC reconfiguration complete message, the WTRU 102 may start (or resume) LTM L1 measurement reporting for candidate cells.

For example, under a condition that a TTT is running (e.g. has started due to a condition being met, but has not yet expired) for a configured RRC Measurement event, the UE may stop or suspend LTM L1 measurement reporting for candidate cells, and when the TTT expires (e.g., and the measurement event is triggered) or is stopped (e.g., the measurement event criteria is no longer met and hence the event is not triggered), the WTRU 102 may start (or resume) LTM L1 measurement reporting for candidate cells.

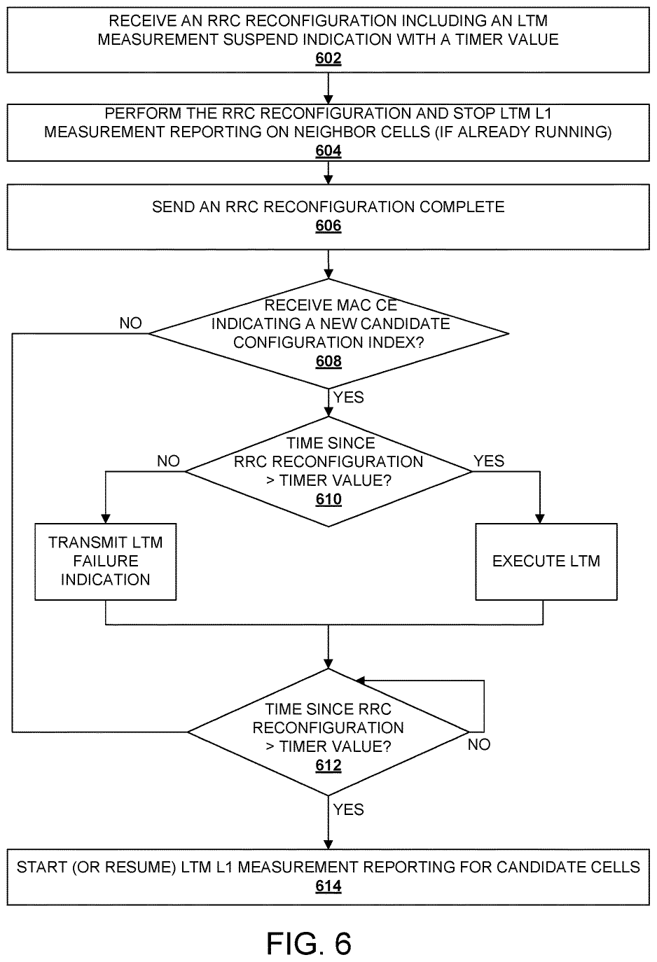

FIG. 6 is a procedural diagram illustrating an example procedure for LTM measurement and execution suspension after a L3 reconfiguration (e.g., handover). At 602 in FIG. 6, a WTRU 102 may receive an RRC reconfiguration message which includes information indicating to suspend LTM measurements and execution. For example, a timer value may be indicated in the RRC Reconfiguration. For example, a timer value may be derived (e.g., based on the number of LTM candidate cells, and/or whether the RRC reconfiguration is performing certain procedures such as security re-initialisation or L2 reset). For example, a fixed timer may be predetermined and/or provided as a standardized value (e.g., in 5G NR). In certain representative embodiments, the indication only suspends LTM measurements and/or measurement reporting. In certain representative embodiments, only LTM execution is suspended. In certain representative embodiments, both measurements and measurement reporting and execution are suspended.

In certain representative embodiments, the RRC reconfiguration may include information indicating one or more LTM candidate cell configurations. For example, the LTM candidate cells may have been previously configured (e.g., by an earlier RRC Reconfiguration) and may be valid after applying the new RRC Reconfiguration. As an example, a RRC reconfiguration may indicate to perform a reconfiguration using a stored LTM configuration (e.g., apply the LTM reconfiguration as indicated by RRC). In certain representative embodiments, a RRC reconfiguration may update previously configured LTM candidate configurations. In certain representative embodiments, the RRC reconfiguration may indicate the serving cell configuration, and may indicate a new SpCell, new SCells, a change of MCG and/or SCG, or any combination thereof.

In certain representative embodiments, the RRC reconfiguration may indicate a handover from one set of LTM cells to another set, such as if the WTRU 102 needs to be reconfigured from one CU to another CU.

At 604 in FIG. 6, the WTRU 102 may apply the received RRC reconfiguration and stop any LTM based measurement reporting (e.g., if running). LTM based measurement reporting may refer to reports of any of LTM candidate cells using L1 measurement events, L1 CSI reporting, and/or L3 reporting. For example, the WTRU 102 may start a timer (e.g., determine a time duration) equal to the indicated value in the RRC reconfiguration. For example, the WTRU 102 may start a timer (e.g., determine a time duration) equal to equal to a derived or implied value. In certain representative embodiments, the timer may be started upon reception of the RRC reconfiguration message. In certain representative embodiments, the timer may be started upon transmission of a RRC reconfiguration complete message. In certain representative embodiments, the timer may be started upon reception of a RLC acknowledgement corresponding to successful delivery of the RRC reconfiguration complete message.

In certain representative embodiments, a first type of L1 CSI reporting may be suspended and a second type of L1 CSI reporting may not be suspended. For example, periodic L1 CSI reporting may be suspended, and aperiodic L1 CSI reporting may not be suspended.

At 606 in FIG. 126 the WTRU 102 may encode and transmit an RRC reconfiguration complete message. As LTM operation is suspended, the WTRU 102 may perform transmission, including any necessary MAC, RLC, and/or PDCP retransmissions, without a cell change occurring due to LTM. Therefore, the message can be delivered on the cell on which it is expected according to the RRC reconfiguration, avoiding any potential error conditions which may be caused by separately controlled mobility procedures (e.g., LTM controlled by DU and RRC controlled by CU).

At 608 and 610 in FIG. 6, if a MAC CE is received (e.g., a MAC CE with an indication to perform a LTM cell switch), and the timer is still running (e.g., the elapsed time since reception of the RRC reconfiguration is less than the indicated timer value, or the elapsed time since transmission or successful acknowledgement of RRC reconfiguration complete is less than the indicated timer value), then the WTRU 102 may not apply the indicated MAC CE. For example, the WTRU 102 may not perform an LTM reconfiguration to the indicated candidate configuration ID. In certain representative embodiments, the WTRU 102 may transmit a failure indication, such as by using a MAC CE or using an RRC Reconfiguration failure message. In certain representative embodiments, the WTRU 102 may include information indicating a cause or reason, which indicates that the failure is due to the LTM suspend timer running. If the timer is no longer running (e.g., the elapsed time since reception of the RRC reconfiguration is greater than or equal to the indicated timer value, or the elapsed time since transmission or successful acknowledgement of RRC reconfiguration complete is greater than or equal to the indicated timer value), then the WTRU 102 may execute a LTM according to the received indication (e.g., perform cell switch to the indicated candidate configuration, or start measurements, synchronization, or any procedure applicable to LTM).

In certain representative embodiments, a priority quantity may be defined (e.g., high priority and/or low priority). For example, the priority may be indicated with an index (e.g., 1 means high priority and 0 means low priority). The priority index may define whether a L1/2 (LTM) cell switch or a L3 handover has a higher priority. The priority may be configured and/or indicated. For example, the priority may be indicated in a MAC CE. In certain representative embodiments, if MAC CE indicating cell switching is received and the priority indicates that L1/2 cell switching has higher priority, then the WTRU 102 may perform a L1/2 switch. In certain representative embodiments, if MAC CE indicating cell switching is received and the priority indicates that L3 cell switching has higher priority, then the WTRU 102 may abort the L1/2 switch when a L3 handover is pending (e.g., a RRC reconfiguration message has been received).

At 612 and 614 in FIG. 6, when the timer expires (e.g., the elapsed time since reception of RRC reconfiguration is greater than or equal to the indicated timer value), then the WTRU 102 may resume L1 measurements or other measurements related to LTM, and may execute any command received from the DU (e.g., a MAC CE) and so on.

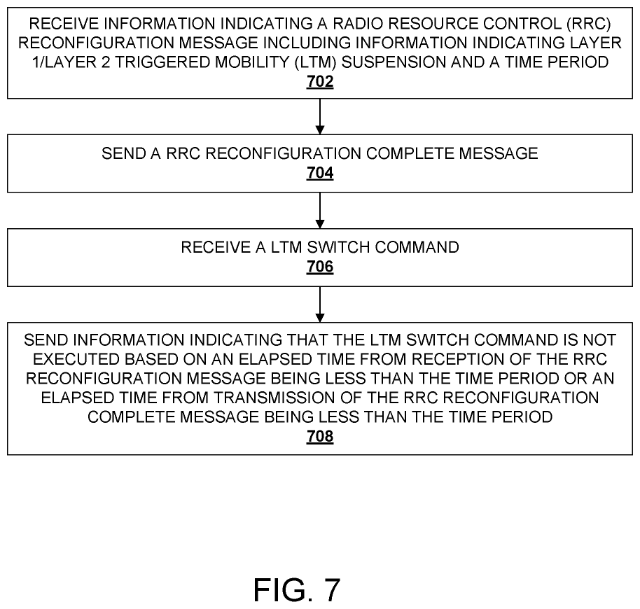

FIG. 7 is a procedural diagram illustrating an example LTM procedure according to certain representative embodiments. In FIG. 7, a WTRU may (e.g., implement a method to) receive information indicating a RRC reconfiguration message including information indicating LTM suspension and a time period at 702. The WTRU may (e.g., perform the RRC reconfiguration and) send a RRC reconfiguration complete message at 704. The WTRU may receive a LTM switch command at 706. The WTRU may send information indicating that the LTM switch command is not executed based on an elapsed time from reception of the RRC reconfiguration message being less than the time period or an elapsed time from transmission of the RRC reconfiguration complete message being less than the time period at 708.

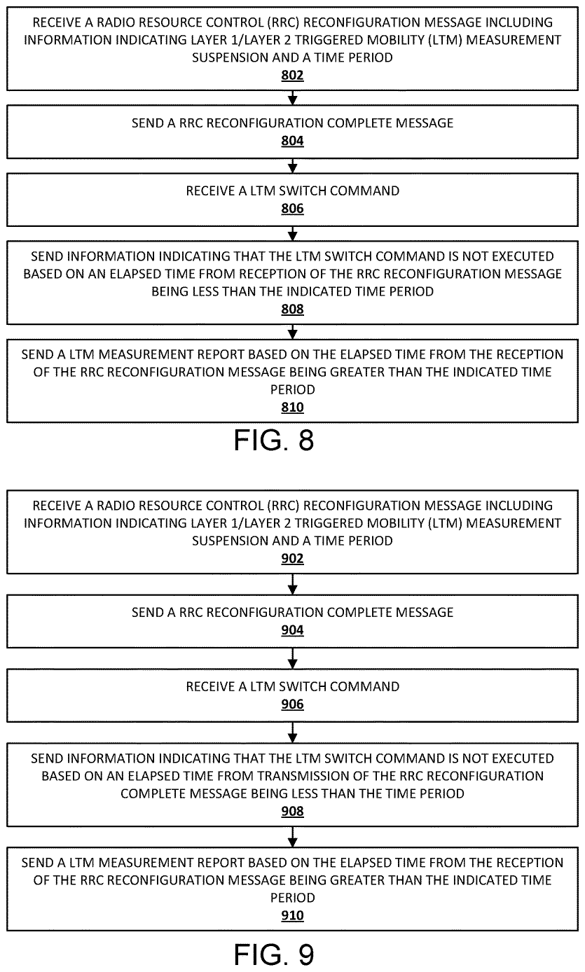

FIG. 8 is a procedural diagram illustrating an example procedure for LTM measurement suspension and measurement reporting. In FIG. 8, a WTRU 102 may receive a RRC reconfiguration message including information indicating LTM measurement suspension and a time period (e.g., associated with the LTM suspension) at 802. At 804, the WTRU 102 may send a RRC reconfiguration complete message. At 806, the WTRU 102 may receive a LTM switch command. At 808, the WTRU 102 may send information indicating that the LTM switch command is not executed based on an elapsed time from reception of the RRC reconfiguration message being less than the indicated time period. At 810, the WTRU 102 may send a LTM measurement report based on the elapsed time from the reception of the RRC reconfiguration message being greater than the indicated time period.

In certain representative embodiments, the WTRU 102 may stop LTM measurement reporting based on the indicated LTM suspension while the elapsed time from reception of the RRC reconfiguration message is less than the indicated time period.

In certain representative embodiments, the information indicating that the LTM switch command is not executed may be a failure indication.

In certain representative embodiments, the information indicating that the LTM switch command is not executed is sent in a MAC CE.

In certain representative embodiments, the WTRU 102 may send a LTM measurement report prior to receiving the RRC reconfiguration message.

FIG. 9 is a procedural diagram illustrating another example procedure for LTM measurement suspension and measurement reporting. In FIG. 9, a WTRU 102 may receive a RRC reconfiguration message including information indicating LTM measurement suspension and a time period (e.g., associated with the LTM suspension) at 902. At 904, the WTRU 102 may send a RRC reconfiguration complete message. At 906, the WTRU 102 may receive a LTM switch command. At 1708, the WTRU 102 may send information indicating that the LTM switch command is not executed based on an elapsed time from transmission of the RRC reconfiguration complete message being less than the time period. At 910, the WTRU 102 may send a LTM measurement report based on the elapsed time from the reception of the RRC reconfiguration message being greater than the indicated time period.

In certain representative embodiments, the WTRU 102 may stop LTM measurement reporting based on the indicated LTM suspension while the elapsed time from reception of the RRC reconfiguration message is less than the indicated time period.

In certain representative embodiments, the information indicating that the LTM switch command is not executed may be a failure indication.

In certain representative embodiments, the information indicating that the LTM switch command is not executed is sent in a MAC CE.

In certain representative embodiments, the WTRU 102 may send a LTM measurement report prior to receiving the RRC reconfiguration message.

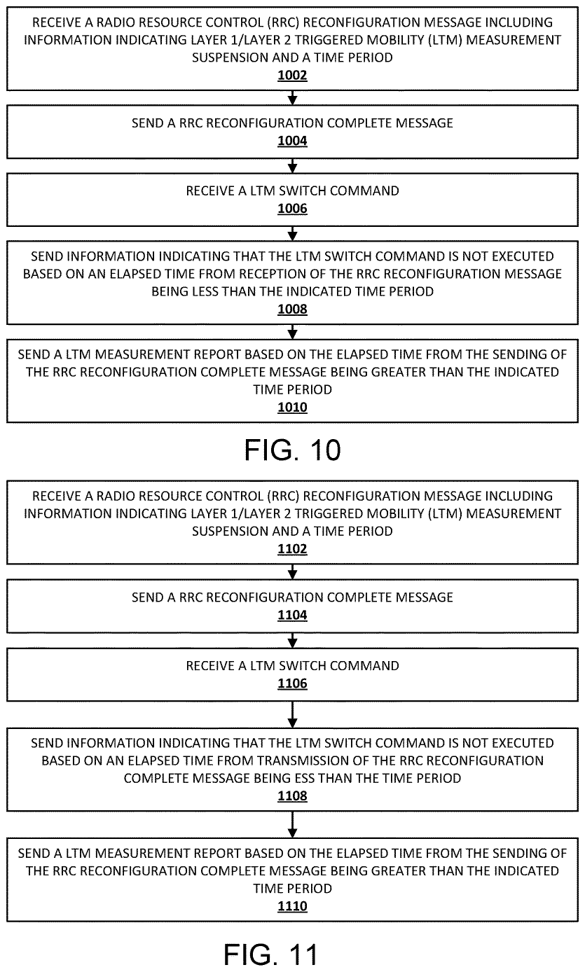

FIG. 10 is a procedural diagram illustrating yet another example procedure for LTM measurement suspension and measurement reporting. In FIG. 10, a WTRU 102 may receive a RRC reconfiguration message including information indicating LTM measurement suspension and a time period (e.g., associated with the LTM suspension) at 1002. At 1004, the WTRU 102 may send a RRC reconfiguration complete message. At 1006, the WTRU 102 may receive a LTM switch command. At 1808, the WTRU 102 may send information indicating that the LTM switch command is not executed based on an elapsed time from reception of the RRC reconfiguration message being less than the indicated time period. At 1010, the WTRU 102 may send a LTM measurement report based on the elapsed time from the sending of the RRC reconfiguration complete message being greater than the indicated time period.

In certain representative embodiments, the WTRU 102 may stop LTM measurement reporting based on the indicated LTM suspension while the elapsed time from the sending of the RRC reconfiguration complete message is less than the indicated time period.

In certain representative embodiments, the information indicating that the LTM switch command is not executed may be a failure indication.

In certain representative embodiments, the information indicating that the LTM switch command is not executed is sent in a MAC CE.

In certain representative embodiments, the WTRU 102 may send a LTM measurement report prior to receiving the RRC reconfiguration message.

FIG. 11 is a procedural diagram illustrating still another example procedure for LTM measurement suspension and measurement reporting. In FIG. 11, a WTRU 102 may receive a RRC reconfiguration message including information indicating LTM measurement suspension and a time period (e.g., associated with the LTM suspension) at 1102. At 1104, the WTRU 102 may send a RRC reconfiguration complete message. At 1106, the WTRU 102 may receive a LTM switch command. At 1108, the WTRU 102 may send information indicating that the LTM switch command is not executed based on an elapsed time from transmission of the RRC reconfiguration complete message being less than the time period. At 1110, the WTRU 102 may send a LTM measurement report based on the elapsed time from the sending of the RRC reconfiguration complete message being greater than the indicated time period.

In certain representative embodiments, the WTRU 102 may stop LTM measurement reporting based on the indicated LTM suspension while the elapsed time from the sending of the RRC reconfiguration complete message is less than the indicated time period.

In certain representative embodiments, the information indicating that the LTM switch command is not executed may be a failure indication.

In certain representative embodiments, the information indicating that the LTM switch command is not executed is sent in a MAC CE.

In certain representative embodiments, the WTRU 102 may send a LTM measurement report prior to receiving the RRC reconfiguration message.

In certain representative embodiments, a WTRU 102 may be configured to (e.g., implement a method) which includes to receive information indicating a RRC reconfiguration message including information indicating LTM suspension and a time period. The WTRU 102 may send a RRC reconfiguration complete message. The WTRU 102 may (e.g., then) receive a LTM switch command. The WTRU 102 may (e.g., then) send information indicating that the LTM switch command is not executed based on an elapsed time from reception of the RRC reconfiguration message being less than the time period or an elapsed time from transmission of the RRC reconfiguration complete message being less than the time period.

For example, the WTRU 102 may stop LTM L1 reporting based on receiving the LTM suspension.

For example, the information indicating that the LTM switch command is not executed may be a failure indication.

For example, the information indicating that the LTM switch command is not executed is sent in a MAC CE.

For example, the WTRU 102 may start the LTM L1 reporting after the elapsed time from reception of the RRC reconfiguration message becomes greater than or equal to the time period.

For example, the WTRU 102 may start the LTM L1 reporting after the elapsed time from transmission of the RRC reconfiguration complete message becomes greater than or equal to the time period.

In an example embodiment, a WTRU may (e.g., implement a method to) receive information indicating configuration information associated with a quality for LTM. The WTRU may receive information indicating a measurement event. The WTRU may determine the quality for a first LTM set based on measurements of a first set of beams from a first plurality of cells. The WTRU may send a measurement report associated with the measurement event and/or perform a conditional reconfiguration based on, for example, (1) the measurement event being satisfied using the determined quality for the first LTM set and (2) an elapsed time since a last LTM cell switch.

For example, the WTRU may determine the quality for a second LTM set based on measurements of a second set of beams from a second plurality of cells. The measurement event may be (e.g., determined to be) satisfied using the determined quality for the first LTM set and the determined quality for the second LTM set. For example, the WTRU may determine the first set of beams as a subset of a (e.g., first) plurality of beams from the first plurality of cells and/or the second set of beams as a subset of a (e.g., second) plurality of beams from the second plurality of cells. For example, the WTRU may determine a quality for a serving or target cell outside of the first LTM set. The measurement event may be (e.g., determined to be) satisfied using the determined quality for the first LTM set and the determined quality for the serving or target cell. For example, the WTRU may perform the last LTM switch before the measurement event is satisfied. For example, the measurement report may include information indicating the determined quality for the first LTM set and/or the conditional reconfiguration may include sending the information indicating the determined quality for the first LTM set.

In certain representative embodiments, a virtual cell quality derivation and/or a modified cell quality derivation may be performed. For example, beams from different cells with a L1/L2 triggered mobility (LTM) candidate set may be used and/or considered to derive the LTM candidate set's virtual cell quality.

In certain representative embodiments, a WTRU may be configured with an active LTM set and a target LTM set. Cell quality derivation and/or comparison may be performed as in legacy procedures, such as using N L1 filtered beam measurements on a cell to derive L3 filtered cell quality. At least one additional triggering condition may (e.g., shall) be fulfilled by a certain number of cells in the target and/or source candidate set.

In certain representative embodiments, a WTRU may switch from a first serving cell to a second serving cell using LTM. When switching, the WTRU may determine a L3 cell quality and evaluate a L3 event trigger based on measurement results applicable to first and second serving cells, such as if the first and second serving cells are a single serving cell. For example, a WTRU may continue evaluation of a (e.g., current) serving cell quality and the measurement event trigger even after a cell change, using the previous serving cell(s) measurements as if they were the current cell measurements.

In certain representative embodiments, a WTRU may perform procedures which allow radio resource control (RRC) reconfiguration complete signaling to be successfully delivered, such as to a centralized unit (CU) of a gNB, after L3 handover, and/or to allow a L3 measurement event evaluation to be completed (e.g., while a time-to-trigger is running). For example, a WTRU may be prevented from sending L1 measurement reports and/or executing LTM which may result in distributed unit (DU) triggered LTM handover and L3 signaling being lost, and/or which may result in a CU detecting handover failure or reconfiguration failure. For example, a WTRU may apply a (e.g., temporary) restriction on neighbor and/or candidate cell L1 reporting, such as with current cell beam reporting still enabled to allow scheduling, by using a timer and/or by waiting for RLC acknowledgement of RRC message (complete) transmission.

In certain representative embodiments, a WTRU may include information indicating a PCell identifier/identity in an uplink (UL) RRC message. For example, the PCell ID may correspond to the PCell at the time the event was triggered (e.g., a measurement event, a RRC reconfiguration). In cases of RRC Reconfiguration, RRC Reconfiguration complete signaling may include information indicating whether RRC Reconfiguration, L2 triggered reconfiguration, or both, have been performed.

In certain representative embodiments, a WTRU may receive configuration information associated with determining LTM quality. The configuration information may include any of: (i) a minimum number of beams and/or cells to use in determining the LTM quality, (ii) offset and/or scaling information, (iii) an association between one or more beams of a serving cell and one or more beams of other cells, and/or (iv) an indication to use LTM quality as a serving cell quality or as an offset to the serving cell quality. The WTRU may receive configuration information indicating a L1 or L3 (L1/L3) measurement event which is associated with a triggering condition. The WTRU may perform first measurements of the one or more beams of the serving cell and the one or more beams of the other cells associated with the serving cell. The WTRU 102 may determine a first LTM quality using the first measurements and the configuration information associated with determining LTM quality. The WTRU may send a report, which includes information indicating the first LTM quality, associated with the L1/L3 measurement event based on the triggering condition being satisfied and a minimum time period since a last LTM cell switch having elapsed.

In certain representative embodiments, a WTRU may receive configuration information associated with determining Layer 1 or Layer 2 (L1/L2) triggered mobility (LTM) quality. For example, the configuration information may include any of: (i) a minimum number of beams and/or cells to use in determining the LTM quality, (ii) offset and/or scaling information, (iii) an association between one or more beams of a target cell and one or more beams of other cells, and/or (iv) an indication to use LTM quality as a target cell quality or as an offset to the target cell quality. The WTRU may receive configuration information indicating a L1 or L3 (L1/L3) measurement event which is associated with a triggering condition. The WTRU may perform first measurements of the one or more beams of the target cell and the one or more beams of the other cells associated with the target cell. The WTRU may determine a first LTM quality using the first measurements and the configuration information associated with determining LTM quality. The WTRU 102 may send a report, which includes information indicating the first LTM quality, associated with the L1/L3 measurement event based on the triggering condition being satisfied and a minimum time period since a last LTM cell switch having elapsed.

In certain representative embodiments, a WTRU may receive configuration information associated with determining Layer 1 or Layer 2 (L1/L2) triggered mobility (LTM) quality. The configuration information may include any of: (i) a minimum number of beams and/or cells to use in determining the LTM quality, (ii) offset and/or scaling information, (iii) an association between one or more beams of a serving cell and one or more beams of other cells, and/or (iv) an indication to use LTM quality as a serving cell quality or as an offset to the serving cell quality. The WTRU 102 may receive configuration information indicating a L1 or L3 (L1/L3) measurement event which is associated with a triggering condition. The WTRU may perform first measurements of the one or more beams of the serving cell and the one or more beams of the other cells associated with the serving cell. The WTRU may determine a first LTM quality using the first measurements and the configuration information associated with determining LTM quality. The WTRU may perform a conditional reconfiguration associated with the L1/L3 measurement event based on the triggering condition being satisfied and a minimum time period since a last LTM cell switch having elapsed.

In certain representative embodiments, a WTRU may receive configuration information associated with determining Layer 1 or Layer 2 (L1/L2) triggered mobility (LTM) quality. The configuration information may include any of: (i) a minimum number of beams and/or cells to use in determining the LTM quality, (ii) offset and/or scaling information, (iii) an association between one or more beams of a target cell and one or more beams of other cells, and/or (iv) an indication to use LTM quality as a target cell quality or as an offset to the target cell quality. The WTRU may receive configuration information indicating a L1 or L3 (L1/L3) measurement event which is associated with a triggering condition. The WTRU may perform first measurements of the one or more beams of the target cell and the one or more beams of the other cells associated with the target cell. The WTRU may determine a first LTM quality using the first measurements and the configuration information associated with determining LTM quality. The WTRU may perform a conditional reconfiguration associated with the L1/L3 measurement event based on the triggering condition being satisfied and a minimum time period since a last LTM cell switch having elapsed.

In certain representative embodiments, a WTRU may receive configuration information associated with determining cell quality using L3 filtering. The WTRU may receive configuration information indicating a measurement event associated with using a time-to-trigger (TTT) period and an offset. The WTRU may determine the measurement event is met at a start of a first time period based on a first triggering condition using a quality of a first serving cell using the L3 filtering and a quality of a neighbor cell. The WTRU may receive information indicating to switch the first serving cell to a second serving cell using layer 1/layer 2 triggered mobility (LTM) at an end of the first time period, wherein the first time period is less than the TTT period. The WTRU may determine that the measurement event is met based on a second triggering condition, during a second time period, based on a quality of the second serving cell during the second time period using the L3 filtering, and a quality of a neighbor cell, wherein the second time period is after the first time period, and a sum of the first time period and the second time period is greater than or equal to the TTT period. The WTRU may send, based on the quality of the neighbor cell being greater than a measurement result of the second serving cell plus the offset, a measurement report including information indicating any of (i) the first serving cell and the second serving cell, and/or (ii) the first and second time periods.

In certain representative embodiments, a WTRU may receive a RRC reconfiguration message including information indicating LTM measurement suspension and a time period (e.g., associated with the LTM suspension). The WTRU may send a RRC reconfiguration complete message. The WTRU may receive a LTM switch command. The WTRU may send information indicating that the LTM switch command is not executed based on an elapsed time from reception of the RRC reconfiguration message being less than the indicated time period. The WTRU may send a LTM measurement report based on the elapsed time from the reception of the RRC reconfiguration message being greater than the indicated time period.

In certain representative embodiments, a WTRU may receive a RRC reconfiguration message including information indicating LTM measurement suspension and a time period (e.g., associated with the LTM suspension). The WTRU may send a RRC reconfiguration complete message. The WTRU may receive a LTM switch command. The WTRU may send information indicating that the LTM switch command is not executed based on an elapsed time from transmission of the RRC reconfiguration complete message being less than the time period. The WTRU may send a LTM measurement report based on the elapsed time from the reception of the RRC reconfiguration message being greater than the indicated time period.

In certain representative embodiments, a WTRU may receive a RRC reconfiguration message including information indicating LTM measurement suspension and a time period (e.g., associated with the LTM suspension). The WTRU may send a RRC reconfiguration complete message. The WTRU may receive a LTM switch command. The WTRU may send information indicating that the LTM switch command is not executed based on an elapsed time from reception of the RRC reconfiguration message being less than the indicated time period. The WTRU may send a LTM measurement report based on the elapsed time from the sending of the RRC reconfiguration complete message being greater than the indicated time period.

In certain representative embodiments, a WTRU may receive a RRC reconfiguration message including information indicating LTM measurement suspension and a time period (e.g., associated with the LTM suspension). The WTRU may send a RRC reconfiguration complete message. The WTRU may receive a LTM switch command. The WTRU may send information indicating that the LTM switch command is not executed based on an elapsed time from transmission of the RRC reconfiguration complete message being less than the time period. The WTRU may send a LTM measurement report based on the elapsed time from the sending of the RRC reconfiguration complete message being greater than the indicated time period.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM) or non-volatile (e.g., Read-Only Memory (ROM) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1.-44. (canceled)

45. A wireless transmit/receive unit (WTRU) comprising:
a processor, memory, and a transceiver which are configured to:
receive a radio resource control (RRC) reconfiguration message including information indicating layer 1/layer 2 triggered mobility (LTM) measurement suspension and a time period,
send a RRC reconfiguration complete message,
receive a LTM switch command,
send information indicating that the LTM switch command is not executed based on an elapsed time from reception of the RRC reconfiguration message being less than the indicated time period, and
send a LTM measurement report based on the elapsed time from the reception of the RRC reconfiguration message being greater than the indicated time period.

46. The WTRU of claim 45, wherein the processor and the transceiver are configured to:
stop LTM measurement reporting based on the indicated LTM suspension while the elapsed time from reception of the RRC reconfiguration message is less than the indicated time period.

47. The WTRU of claim 45, wherein the information indicating that the LTM switch command is not executed is a failure indication.

48. The WTRU of claim 45, wherein the information indicating that the LTM switch command is not executed is sent in a medium access control (MAC) control element (CE).

49. The WTRU of claim 45, wherein the processor and the transceiver are configured to:
send a LTM measurement report prior to receiving the RRC reconfiguration message.

50. A wireless transmit/receive unit (WTRU) comprising:
a processor, memory, and a transceiver which are configured to:
receive a radio resource control (RRC) reconfiguration message including information indicating layer 1/layer 2 triggered mobility (LTM) measurement suspension and a time period,
send a RRC reconfiguration complete message,
receive a LTM switch command,
send information indicating that the LTM switch command is not executed based on an elapsed time from transmission of the RRC reconfiguration complete message being less than the time period, and
send a LTM measurement report based on the elapsed time from the reception of the RRC reconfiguration message being greater than the indicated time period.

51. The WTRU of claim 50, wherein the processor and the transceiver are configured to:
stop LTM measurement reporting based on the indicated LTM suspension while the elapsed time from reception of the RRC reconfiguration message is less than the indicated time period.

52. The WTRU of claim 50, wherein the information indicating that the LTM switch command is not executed is a failure indication.

53. The WTRU of claim 50, wherein the information indicating that the LTM switch command is not executed is sent in a medium access control (MAC) control element (CE).

54. The WTRU of claim 50, wherein the processor and the transceiver are configured to:
send a LTM measurement report prior to receiving the RRC reconfiguration message.

55. A wireless transmit/receive unit (WTRU) comprising:
a processor, memory, and a transceiver which are configured to:
receive a radio resource control (RRC) reconfiguration message including information indicating layer 1/layer 2 triggered mobility (LTM) measurement suspension and a time period,
send a RRC reconfiguration complete message,
receive a LTM switch command,
send information indicating that the LTM switch command is not executed based on an elapsed time from reception of the RRC reconfiguration message being less than the indicated time period, and
send a LTM measurement report based on the elapsed time from the sending of the RRC reconfiguration complete message being greater than the indicated time period.

56. The WTRU of claim 55, wherein the processor and the transceiver are configured to:
stop LTM measurement reporting based on the indicated LTM suspension while the elapsed time from the sending of the RRC reconfiguration complete message is less than the indicated time period.

57. The WTRU of claim 55, wherein the information indicating that the LTM switch command is not executed is a failure indication.

58. The WTRU of claim 55, wherein the information indicating that the LTM switch command is not executed is sent in a medium access control (MAC) control element (CE).

59. The WTRU of claim 55, wherein the processor and the transceiver are configured to:
send a LTM measurement report prior to receiving the RRC reconfiguration message.
